(19) United States
(12) Patent Application Publication
(10) Pub. No.: US 2008/0160439 A1
(43) Pub. Date: Jul. 3, 2008

(54) Electrophotographic photoreceptor, method of preparation, and electrophotographic imaging apparatus

(75) Inventors: Saburo Yokota, Suwon-si (KR); Moto Makino, Suwon-si (KR); Hwan-koo Lee, Suwon-si (KR); Beom-jun Kim, Yongin-si (KR); Seung-ju Kim, Suwon-si (KR); Ji-young Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/812,877

(22) Filed: Jun. 22, 2007

(30) Foreign Application Priority Data
Dec. 28, 2006 (KR) 10-2006-0136839

(51) Int. Cl. G03G 15/04

(52) U.S. Cl. 430/69; 399/159

(57) ABSTRACT

An electrophotographic photoreceptor includes a photosensitive layer including a charge generating material, a charge transporting material and a binder resin in a single layer, formed on an electrically conductive substrate. The single photosensitive layer includes an upper photosensitive layer portion and a lower photosensitive layer portion. The upper photosensitive layer portion has a higher concentration of the electron transporting material than that of the lower photosensitive layer portion. A method of preparing the electrophotographic photoreceptor, and an electrophotographic imaging apparatus employing the electrophotographic photoreceptor are provided. The single-layered type electrophotographic photoreceptor according to the present invention shows high sensitivity and excellent repetition stability of electrical properties, while still having advantages of a conventional single-layered photoreceptor, thereby being able to have highly practical applications.

### CROSS-REFERENCE TO RELATED PATENT APPLICATION

This application claims the benefit of Korean Patent Application No. 10-2006-0136839, filed on Dec. 28, 2006, in the Korean Intellectual Property Office, the disclosure of which is hereby incorporated by reference in its entirety.

### BACKGROUND OF THE INVENTION

1. Field of the Invention

The present invention relates to an electrophotographic photoreceptor, a method of preparing the electrophotographic photoreceptor, and an electrophotographic imaging apparatus employing the electrophotographic photoreceptor. More particularly, the invention is directed to a single-layered electrophotographic photoreceptor having high sensitivity and excellent repetition stability of electrical properties.

2. Description of the Related Art

In electrophotographic devices such as laser printers, photocopiers, and the like, electrophotographic photoreceptors, which comprise a photosensitive layer formed on an electrically conductive substrate in the form of a plate, a disk, a sheet, a belt, a drum or the like, form an image as follows. First, a surface of the photosensitive layer is uniformly and electrostatically charged, and then the charged surface is exposed to a pattern of light, thus forming the image. The light exposure selectively dissipates the charge in the exposed regions where the light strikes the surface, thereby forming a pattern of charged and uncharged regions, referred to as a latent image. Then, a wet or dry toner is provided in the vicinity of the latent image, and toner droplets or particles are deposited in either the charged or uncharged regions to form a toner image on the surface of the photosensitive layer. The resulting toner image can be transferred and fixed to a suitable ultimate or intermediate receiving surface, such as paper, or the photosensitive layer can function as the ultimate receptor for receiving the image.

Electrophotographic photoreceptors are widely categorized into two types according to the structure of the photosensitive layer. The first is a laminated-type having a laminated structure including a charge generating layer (CGL) comprising a binder resin and a charge generating material (CGM), and a charge transporting layer (CTL) comprising a binder resin and a charge transporting material (usually, a hole transporting material (HTM)). In general, the laminated-type electrophotographic photoreceptor is used in the fabrication of a negative (−) type electrophotographic photoreceptor. The other type is a single layered-type in which a binder resin, a CGM, an HTM, and an electron transporting material (ETM) are included in a single layer. In general, the single layered-type electrophotographic photoreceptor is used in the fabrication of a positive (+) type electrophotographic photoreceptor.

Laminated-type electrophotographic photoreceptors in which the charge generating and charge transporting functions are separated are widely used. However, single layered-type electrophotographic photoreceptors have recently been actively researched and developed, since they can be produced using a simple manufacturing process, and are positive charge-type electrophotographic photoreceptors that can be used with positive (+) corona discharge in which less ozone is generated.

Representative examples of single layered-type electrophotographic photoreceptors include a photoreceptor including a single layered photosensitive layer comprising a charge moving complex such as poly(N-vinylcarbazole)/2,4,7-trinitro-9-fluorenone (PVK/TNF), which is disclosed in U.S. Pat. No. 3,484,237, a photoreceptor including a photosensitive layer in which photoconductive phthalocyanine is dispersed in a binder resin, which is disclosed in U.S. Pat. No. 3,397,086, a photoreceptor including a photosensitive layer in which an aggregate of thiapyrylium and polycarbonate together with a charge transporting material is dispersed in a binder resin, which is disclosed in U.S. Pat. No. 3,615,414, and the like. However, single layered-type electrophotographic photoreceptors as disclosed above are not widely used, since they have insufficient electrical properties and materials that can be used for their manufacture are highly limited, harmful, or the like.

Currently, the most common type of single layered-type electrophotographic photoreceptor is a photoreceptor having a configuration in which a charge generating material is dispersed in a resin together with a hole transporting material and an electron transporting material. In such photoreceptors, both a charge generating material and a charge transporting material are used, and thus, the function of charge generation and charge transportation are assumed separately by the charge generating material and the charge transporting material, respectively. Therefore, there is a wide range of materials that may be used for the photoreceptor. In addition, the charge generating material may have a lower concentration. Accordingly, a photoreceptor having improved mechanical durability and chemical durability can be produced. However, single layered-type electrophotographic photoreceptors have fundamental problems in that the residual potential is high, and the repetition stability of electrical properties is reduced. In single layered-type electrophotographic photoreceptors having the configuration as described above, these problems are caused because charges are generated by a charge generating material that is uniformly dispersed in the photosensitive layer so that the injection and transportation of holes and electrons have to be simultaneously and efficiently implemented, and because it is easy for electrons with low mobility to remain in a low electric field region in which a transporting efficiency is reduced.

To address these problems, a method in which an amount of an electron transporting material in relation to a hole transporting material can be increased as disclosed in Japanese Patent Laid-Open Publication No. 2003-107759. However, to maintain the mechanical strength of a photosensitive layer, the amount of charge transporting materials, which is the sum of the amounts of a hole transporting material and an electron transporting material, cannot be unlimitedly increased. That is, when the amount of the electron transporting material in relation to the hole transporting material is increased, the amount of the hole transporting material has to be reduced. Therefore, the mobility of holes towards an electrically conductive substrate from a surface of the photosensitive layer is reduced, resulting in deterioration of characteristics of the electrophotographic photoreceptor.

### SUMMARY OF THE INVENTION

The present invention provides an electrophotographic photoreceptor with improved electrical properties, while still having the advantages of a conventional single-layered photoreceptor.

The present invention also provides a method of preparing an electrophotographic photoreceptor with improved electrical properties, while still having the advantages of a conventional single-layered photoreceptor.

The present invention also provides an electrophotographic imaging apparatus employing the electrophotographic photoreceptor.

According to an aspect of the present invention, an electrophotographic photoreceptor is provided comprising a photosensitive layer comprising a charge generating material, a charge transporting material and a binder resin in a single layer, formed on an electrically conductive substrate, wherein the single photosensitive layer comprises an upper photosensitive layer portion and a lower photosensitive layer portion, and where the electron transporting material of the upper photosensitive layer portion is present in a higher concentration than the lower photosensitive layer portion.

Preferably according to one embodiment of the invention, an interface region is formed between the upper and lower photosensitive layer portions. The interface region is a composition of the two layer portions mixed with each other in such a manner that the concentration of the electron transporting material increases continuously towards the direction of the upper photosensitive layer portion.

Preferably, the concentration of the hole transporting material in the lower photosensitive layer portion is higher than that of the upper photosensitive layer portion.

Preferably, the electrophotographic photoreceptor is a positive charge type.

According to another aspect of the present invention, a method of preparing an electrophotographic photoreceptor is provided, comprising:

forming a lower photosensitive layer portion on an electrically conductive substrate; and

applying a dispersion for forming an upper photosensitive layer portion, comprising an electron transporting material and a solvent in which the electron transporting material and the lower photosensitive layer portion can be dissolved, on the lower photosensitive layer portion to form an upper photosensitive layer portion, whereby at an interface region between the upper and lower photosensitive layer portions, compositions of the two layer portions are mixed with each other in such a manner that the concentration of the electron transporting material increases continuously towards the direction of the upper photosensitive layer portion, and the upper photosensitive layer portion has a higher concentration of an electron transporting material than that of the lower photosensitive layer portion.

According to another aspect of the present invention, an electrophotographic imaging apparatus is provided comprising: an electrophotographic photoreceptor; a charging unit that charges a photosensitive layer of the electrophotographic photoreceptor; a light exposure unit that forms a latent image on a surface of the photosensitive layer of the electrophotographic photoreceptor by light exposure using laser light; and a developer that develops the latent image, wherein electrophotographic photoreceptor comprises a photosensitive layer comprising a charge generating material, a charge transporting material and a binder resin in a single layer, formed on an electrically conductive substrate, wherein the single photosensitive layer comprises an upper photosensitive layer portion and a lower photosensitive layer portion, and where the concentration of the electron transporting material of the upper photosensitive layer portion is higher than that of the lower photosensitive layer portion.

A single-layered electrophotographic photoreceptor according to the present invention, having the structural features as described above, shows high sensitivity and excellent repetition stability of electrical properties, while still having the advantages of a conventional single-layered photoreceptor, thereby being able to have highly practical applications.

These and other aspects of the invention will become apparent from the following detailed description of the invention which disclose various embodiments of the invention.

### BRIEF DESCRIPTION OF THE DRAWING

The above and other features and advantages of the present invention will become more apparent by describing in detail exemplary embodiments thereof with reference to FIG. 1:

FIG. 1 is a diagram illustrating an electrophotographic imaging apparatus according to an embodiment of the present invention.

### DETAILED DESCRIPTION OF THE INVENTION

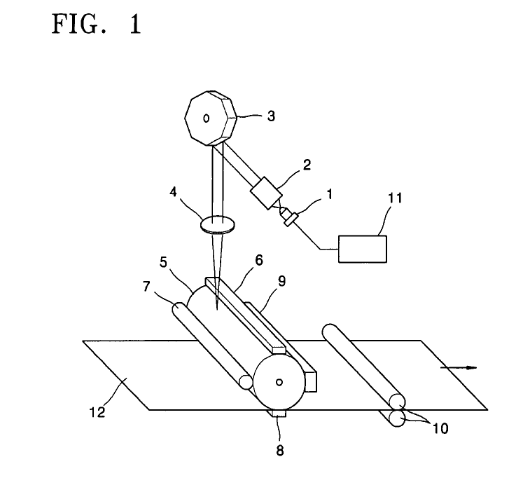

Hereinafter, a single-layered electrophotographic photoreceptor according to the present invention will be described in detail with reference to FIG. 1.

The electrophotographic photoreceptor includes a photosensitive layer, which comprises a charge generating material, a charge transporting material and a binder resin in a single layer, formed on an electrically conductive substrate. The single photosensitive layer comprises an upper photosensitive layer portion and a lower photosensitive layer portion. The upper photosensitive layer portion has a larger amount of electron transporting materials than that of the lower photosensitive layer portion. Because of this structural characteristic, the electrophotographic photoreceptor of the present invention can have improved sensitivity and excellent repetition stability of electrical properties, thereby having more practical applications.

Preferably, at an interface region between the upper and lower photosensitive layer portions, an interface composition of the two layer portions is formed by mixing with each other in such a manner that the concentration of the electron transporting material increases continuously towards the direction of the upper photosensitive layer portion. If compositions at the interface region between the upper photosensitive layer portion and the lower photosensitive layer portion change discontinuously or abruptly, an energy barrier is formed therebetween, and thus charges cannot be properly injected into the photosensitive layer. As a result, electrical properties of the photosensitive layer are easily degradable. To prevent this from occurring, it is preferable that the interface region between the upper and lower photosensitive layer portions be formed from a mixture of the two layer portions such that the concentration of the electron transporting material increases continuously towards the direction of the upper photosensitive layer portion. In another embodiment, the photosensitive layer has an upper outer surface and a lower surface adhered to the electrically conductive substrate where the concentration of the electron transporting material continuously increases from the lower surface to the upper surface.

The upper photosensitive layer portion comprises an electron transporting material. In addition, the upper photosensitive layer portion may further comprise a binder resin, a hole transporting material, a charge generating material or the like, if needed. In particular, the upper photosensitive layer portion may comprise a binder resin to increase the durability of the upper layer, since this portion is susceptible to mechanical friction caused by contact with paper or a developing device, a toner cleaning operation, or the like. In addition, the upper photosensitive layer portion may comprise a charge generating material in order to efficiently generate charges in the upper layer, and may comprise a hole transporting material in order to efficiently transport generated holes to the lower photosensitive layer portion. The materials used in forming the upper photosensitive layer portion may be the same or different from those used in forming the lower photosensitive layer portion. When different materials are used, an energy barrier may be formed between the upper and lower photosensitive layer portions. Therefore, caution has to be applied in selecting materials.

The lower photosensitive layer portion may have a higher concentration of a hole transporting material than that of the upper photosensitive layer portion.

In an electrophotographic photoreceptor according to an embodiment of the present invention, the upper photosensitive layer portion comprises a binder resin, and a charge generating material, an electron transporting material and a hole transporting material that are dispersed or dissolved in the binder resin of the upper layer. In addition, the lower photosensitive layer portion comprises a binder resin, and a charge generating material and a hole transporting material that are dispersed or dissolved in the binder resin of the lower layer. In the upper photosensitive layer portion in one embodiment, amounts of the charge generating material, the electron transporting material and the hole transporting material, may be about 0.1-200 parts by weight, about 15-300 parts by weight and about 5-100 parts by weight, respectively, based on 100 parts by weight of the binder resin of the upper photosensitive layer portion. In the lower photosensitive layer portion, amounts of the charge generating material and the hole transporting material, may be about 0.1-200 parts by weight and about 20-400 parts by weight, respectively, based on 100 parts by weight of the binder resin of the lower photosensitive layer portion.

The amount of the charge generating material in the upper photosensitive layer portion may be preferably about 0.1-200 parts by weight based on 100 parts by weight of the binder resin of the upper photosensitive layer portion, more preferably about 1-100 parts by weight, and most preferably about 2-30 parts by weight based on 100 parts by weight of the binder resin. When the amount of the charge generating material in the upper photosensitive layer portion is less than 0.1 parts by weight based on 100 parts by weight of the binder resin of the upper photosensitive layer portion, the amount of charge generation is insufficient, and thus, the sensitivity is reduced, resulting in an increase in residual potential. When the amount of the charge generating material of the upper photosensitive layer portion is greater than 200 parts by weight based on 100 parts by weight of the binder resin in the upper photosensitive layer portion, the amount of the binder resin of the upper photosensitive layer portion is reduced, and thus the mechanical strength of the upper photosensitive layer portion and the dispersion stability of the charge generating material are reduced.

The amount of the electron transporting material of the upper photosensitive layer portion may be preferably about 15-300 parts by weight based on 100 parts by weight of the binder resin of the upper photosensitive layer portion, more preferably about 20-200 parts by weight, and most preferably about 30-100 parts by weight based on 100 parts by weight of the binder resin.

The amount of the hole transporting material of the upper photosensitive layer portion may be preferably about 5-100 parts by weight based on 100 parts by weight of the binder resin of the upper photosensitive layer portion, more preferably about 10-100 parts by weight, and most preferably about 15-100 parts by weight based on 100 parts by weight of the binder resin.

When the amounts of the electron and hole transporting materials of the upper photosensitive layer portion as described above are less than these ranges, the charge transporting ability is insufficient, and thus sensitivity becomes reduced, resulting in an increase in residual potential. When the amounts of the electron and hole transporting materials of the upper photosensitive layer portion as described above are greater than these ranges, the amount of the binder resin of the upper photosensitive layer portion is reduced, and thus the mechanical strength of the upper photosensitive layer portion is reduced.

The amount of the charge generating material of the lower photosensitive layer portion may be preferably about 0.1-200 parts by weight based on 100 parts by weight of the binder resin of the lower photosensitive layer portion, more preferably about 1-100 parts by weight, and most preferably about 2-30 parts by weight based on 100 parts by weight of the binder resin.

The amount of the hole transporting material of the lower photosensitive layer portion may be preferably about 20-400 parts by weight based on 100 parts by weight of the binder resin of the lower photosensitive layer portion, more preferably about 30-150 parts by weight, and most preferably about 40-120 parts by weight based on 100 parts by weight of the binder resin.

In an electrophotographic photoreceptor according to another embodiment of the present invention, the lower photosensitive layer portion can further comprise about 5-100 parts by weight of an electron transporting material based on 100 parts by weight of the binder resin of the lower photosensitive layer portion.

The total amount of the electron and hole transporting materials in the overall photosensitive layer comprised of the lower and upper photosensitive layer portion may be in the range of about 10-60 weight % based on the total weight of the upper and lower photosensitive layer portions. When the total amount of the electron and hole transporting materials is less than 10 weight % based on the total weight of the upper and lower photosensitive layer portions, the charge transporting ability is insufficient, and thus, the sensitivity is reduced, resulting in an increase in residual potential. When the total amount of the electron and hole transporting materials is greater than 60 weight % based on the total weight of the upper and lower photosensitive layer portions, the amount of the binder resins of the upper and lower photosensitive layer portions is reduced, and thus the mechanical strength of the overall photosensitive layer is reduced.

The total thickness of the upper and lower photosensitive layer portions may be preferably about 5-50 μm, more preferably about 10-40 μm, and most preferably about 15-30 μm. When the total thickness of the upper and lower photosensitive layer portions is less than 5 μm, the sensitivity and mechanical durability of the overall photosensitive layer are reduced. When the total thickness of the upper and lower photosensitive layer portions is greater than 50 μm, the total thickness thereof is too thick, and thus, the electrophotographic properties of the electrophotographic photoreceptor deteriorate.

The electrophotographic receptor according to the present invention may be a positive charge type single-layered electrophotographic receptor.

The reasons for the electrophotographic receptor according to the present invention having excellent properties can be understood as follows.

The inventors of the present invention repeatedly studied a single-layered photoreceptor, and discovered that charges were generated at a surface of a photosensitive layer and at an interface between the photosensitive layer and a substrate in a single-layered photoreceptor. That is, it was discovered that light energy that was absorbed into a photosensitive layer did not directly generate charges in the photosensitive layer, but when light energy passed through the inside of the photosensitive layer to reach the surface of the photosensitive layer and the interface between the photosensitive layer and the substrate, charges were first generated.

In the case of positive charge type photoreceptor, holes generated by charge generation on a surface of a photosensitive layer are transported towards a substrate. On the other hand, when charges are generated at an interface between the photosensitive layer and the substrate, electrons are transported towards the surface of the photosensitive layer. That is, it can be shown that a hole transporting material contributes greatly to the mobility of charges generated on the surface of the photosensitive layer.

However, when charges are generated on a surface of the photosensitive layer, a charge generating material existing around the surface thereof generates charges. Therefore, unless generated electrons rapidly reach positive charges on the surface of the photosensitive layer and are neutralized, space charges are accumulated. As a result, the repetition stability of electrical properties of the electrophotographic photoreceptor degrades. That is, a high electron transporting efficiency is needed around the surface of the photosensitive layer. In a conventional single-layered electrophotographic photoreceptor, the entire photosensitive layer has a uniform composition, and thus, when it has a sufficient amount of a hole transporting material, which can sufficiently transport holes towards a substrate, it is inevitable that the amount of an electron transporting material is reduced proportionally. As a result, the electron transporting efficiency on a surface of the photosensitive layer deteriorates.

In the electrophotographic photoreceptor according to the present invention, the concentration of the electron transporting material of the upper photosensitive layer portion is sufficiently high that electrons are easily disassociated and transported. In addition, since the concentration of the hole transporting material of the lower photosensitive layer portion is high, the mobility of holes moving towards a substrate is not reduced and the amount of the electron transporting material in the whole photosensitive layer is increased. As a result, the electrophotographic photoreceptor according to the present invention can have high sensitivity. Furthermore, there is little or no accumulation of electrons trapped at an interface between the photosensitive layer and the substrate to prevent deterioration of the electrical properties of the electrophotographic photoreceptor when it is repeatedly used, and thus, the repetition stability of electrical properties is also good.

The electrically conductive substrate may be a metal material such as aluminum, an aluminum alloy, stainless steel, copper, nickel or the like; or an insulating substrate such as a polyester film, paper, glass or the like having an electrically conductive layer such as aluminum, copper, palladium, tin oxide, indium oxide or the like. The electrically conductive substrate is in the form of a drum, pipe, belt, plate, or the like.

Examples of the binder resin for the upper and lower photosensitive layer portions include a thermoplastic resin such as a styrene-butadiene copolymer, a styrene-acrylonitrile copolymer, a styrene-maleic acid copolymer, an acrylic resin, a methacrylic resin, a styrene-acrylic acid copolymer, polyethylene, an ethylene-vinylacetate copolymer, chlorinated polyethylene, polyvinylacetate, polyvinylchloride, polyvinylidenechloride, polypropylene, ionomer, a vinylchloride-vinylacetate copolymer, polyester, an alkyd resin, polyamide, polyurethane, polycarbonate, polyacrylate, polystyrene, polysulfone, a diallylphthalate resin, poly-N-vinylcarbazole, a ketone resin, polyvinylformal, a polyvinylbutyral resin, a polyvinyl acetal resin, a phenoxy resin, a polyether resin, carboxymethyl cellulose, polyvinyl alcohol, ethyl cellulose or the like, a crosslinkable thermoset resin such as a silicone resin, an epoxy resin, a phenolic resin, an urea resin, a melamine resin, a silicone-alkyd resin, a styrene-alkyd resin or the like, a photo-curable resin such as epoxy acrylate, urethane acrylate or the like. However, the binder resin is not limited to these examples. The binder resin as described above can be used alone or in a combination of two or more binder resins. The binder resins of the upper and lower photosensitive layer can be the same or different.

Examples of the charge generating material contained in the photosensitive layer according to the present invention include various organic pigments or dyes such as an azo-based compound, a quinone-based compound, a perylene-based compound, an indigo-based compound, a thioindigo-based compound, a bisbenzoimidazole-based compound, a phthalocyanine-based compound, a quinacridone-based compound, a quinoline-based compound, a lake pigment, an azo lake pigment, an anthraquinone-based compound, an oxazine-based compound, a dioxazine-based compound, a triphenylmethane-based compound, an azulenium-based compound, a squarylium-based compound, a pyrylium-based compound, a triarylmethane-based compound, a xanthene-based compound, a thiazin-based compound, a cyanine-based compound or the like; and inorganic materials such as amorphous silicon, amorphous selenium, tellurium, selenium-tellurium alloy, cadmium sulfide, antimony sulfide, zinc oxide, zinc sulfide or the like. The charge generating material as described above can be used alone or in a combination of two or more.

The hole transporting material includes a low molecular weight hole transporting material and/or a high molecular weight hole transporting material. Examples of the low molecular weight hole transporting material include a pyrene-based compound, a carbazole-based compound, a hydrazone-based compound, an oxazole-based compound, an oxadiazole-based compound, a pyrazoline-based compound, an arylamine-based compound, an arylmethane-based compound, a benzidine-based compound, a thiazole-based compound, a stilbene-based compound, a butadiene-based compound or the like. Examples of the high molecular weight hole transporting material include poly-N-vinylcarbazole, halogenated poly-N-vinylcarbazole, polyvinylpyrene, polyvinylanthracene, polyvinylacrydine, a pyrene-formaldehyde resin, an ethylcarzoleformaldehyde resin, a triphenylmethane polymer, polysilane or the like.

The hole transporting material contained in the photosensitive layer according to the present invention is not limited to the materials described above, and can be used alone or in a combination of two or more.

Examples of the electron transporting material include an electron attracting low-molecular weight compound such as a benzoquinone-based compound, a tetracyanoethylene-based compound, a tetraquinodimethane-based compound, a xanthone-based compound, a phenanthraquinone-based compound, a phthalic anhydride-based compound, a naphthalene-based compound, a thiopyrane-based compound, a naphthoquinone-based compound, an anthraquinone-based compound, a malononitrile-based compound, a fluorenone-based compound, a dicyanofluorenone-based compound, a benzoquinoneimine-based compound, a diphenoquinone-based compound, a stilbene quinone-based compound, a diiminoquinone-based compound, a dioxotetracenedione-based compound, a thiopyrane-based compound or the like, but are not limited thereto. The electron transporting material can be a high molecular weight compound or pigment having an electron transporting ability.

However, the charge transporting material is not limited to the materials described above, and can be used alone or in a combination of two or more materials.

Each of the upper and lower photosensitive layer portions may further comprise additives such as a dispersion stabilizer, a plasticizer, a surface modifier, an anti-oxidant, an anti-photodegradation agent or the like, in addition to the constituents described above.

The plasticizer may be biphenyl, biphenyl chloride, terphenyl, dibutyl phthalate, diethyleneglycol phthalate, dioctyl phthalate, triphenyl phosphate, methylnaphthalene, benzophenone, chlorinated paraffin, polypropylene, polystyrene, fluoro-hydrocarbon or the like.

The surface modifier may be silicone oil, a fluoro-resin, or the like.

The anti-oxidant may be a phenol-based compound, a sulfur-based compound, a phosphorous-based compound, an amine-based compound or the like. Examples of the phenol-based anti-oxidizing agent include 2,6-di-tert-butylphenol, 2,6-di-tert-butyl-4-methoxyphenol, 2,6-di-tert-butyl-4-methylphenol, 2-tert-butyl-4-methoxyphenol, 2,4-dimethyl-6-tert-butylphenol, 2-tert-butylphenol, 3,6-di-tert-butylphenol, 2,4-di-tert-butylphenol, 2,6-di-tert-butyl-4-ethylphenol, 2-tert-butyl-4,6-methyl phenol, 2,4,6-tert-butylphenol, 2,6-di-tert-butyl-4-stearyl propionate phenol, α-tocopherol, β-tocopherol, γ-tocopherol, naphthol AS, naphthol AS-D, naphthol AS—BO, 4,4′-methylene bis(2,6-di-tert-butylphenol), 4,4′-methylene bis(6-tert-butyl-4-methylphenol), 2,2′-methylene bis(4-methyl-6-tert-butylphenol), 2,2′-methylene bis(4-ethyl-6-tert-butylphenol), 2,2′-ethylene bis(4,6-di-tert-butylphenol), 2,2′-propylene bis(4,6-di-tert-butylphenol), 2,2′-butane bis (4,6-di-tert-butylphenol), 2,2′-ethylene bis(6-tert-butyl-m-cresol), 4,4′-butane bis (6-tert-butyl-m-cresol), 2,2′-butanebis(6-tert-butyl-p-cresol), 2,2′-thiobis ((6-tert-butylphenol), 4,4′-thiobis(6-tert-butyl-m-cresol), 4,4′-thiobis(6-tert-o-cresol), 2,2′-thiobis(4-methyl-6-tert-butylphenol), 1,3,5-trimethyl-2,4,6-tris (3,5-di-tert-butyl-4-hydroxybenzyl)benzene, 1,3,5-trimethyl-2,4,6-tris(3,5-di-tert-amyl-4-hydroxybenzyl)benzene, 1,3,5-trimethyl-2,4,6-tris(3-tert-butyl-5-methyl-4-hydroxybenzyl)benzene, 2-tert-butyl-5-methyl-phenyl amine phenol, 4,4′-bis amino(2-tert-butyl-4-methyl phenol), N-octadecyl-3-(3′,5′-di-tert-butyl-4′-hydroxyphenyl)propionate, 2,2,4-trimethyl-6-hydroxy-7-tert-butyl chroman, tetrakis(methylene-3(3,5-di-tert-butyl-4-hydroxyphenyl)propionate)methane, 1,1,3-tris(2-methyl-4-hydroxy-5-tert-butylphenyl)butane and mixtures thereof, but are not limited thereto. Examples of the phosphorous-based anti-oxidant include tri(2,4-di-t-butylphenyl)phosphite, bis(2,4-di-t-butylphenyl)pentaerythritol diphosphite, bis(2,4-dicumylphenyl)pentaerythritol diphosphite, tri(4-n-nonylphenyl)phosphite, tetrakis(2,4-di-tert-butyl-phenyl)-4,4′-biphenylene-diphosphite, mixtures thereof and the like, but are not limited thereto.

The anti-photodegradation agent may be benzotriazoles, benzophenones, hindered amines or the like.

Hereinafter, a method of preparing an electrophotographic photoreceptor according to the present invention will be described in detail.

The method of preparing an electrophotographic photoreceptor according to the present invention includes forming a lower photosensitive layer portion on an electrically conductive substrate; and applying a composition for forming an upper photosensitive layer portion on the lower photosensitive layer. The composition for forming the upper photosensitive layer comprises an electron transporting material and a solvent in which the electron transporting material and the lower photosensitive layer portion can be dissolved. At an interface region between the upper and lower photosensitive layer portions, the compositions of the two layer portions are mixed with each other in such a manner that the concentration of the electron transporting material increases continuously towards the direction of the upper photosensitive layer portion, and the upper photosensitive layer portion has a higher concentration of an electron transporting material than that of the lower photosensitive layer portion.

In a method of preparing the electrophotographic photoreceptor according to an embodiment of the present invention, the lower photosensitive layer portion is formed by applying and drying a composition comprising a binder resin, a charge generating material, a hole transporting material and a solvent, on the electrically conductive substrate.

The upper photosensitive layer portion is formed by applying and drying a composition comprising a binder resin, a charge generating material, an electron transporting material and a solvent, the solvent being able to dissolve at least the electron transporting material and the lower photosensitive layer portion, on the lower photosensitive layer portion.

In the composition for forming a lower photosensitive layer portion, the amounts of the charge generating material, the hole transporting material and the solvent, may be about 0.1-200 parts by weight, about 20-400 parts by weight and about 50-1000 parts by weight, respectively, based on 100 parts by weight of the binder resin.

In the composition for forming an upper photosensitive layer portion, the amounts of the charge generating material, the electron transporting material, a hole transporting material and the solvent may be about 0.1-200 parts by weight, about 15-300 parts by weight, about 5-100 parts by weight and about 50-1000 parts by weight, respectively, based on 100 parts by weight of the binder resin.

In a method of preparing the electrophotographic photoreceptor, according to another embodiment of the present invention, the composition for forming the lower photosensitive layer portion may further contain about 5-100 parts by weight of an electron transporting material based on 100 parts by weight of the binder resin of the lower photosensitive layer portion.

If compositions at the interface region between the upper photosensitive layer portion and the lower photosensitive layer portion change discontinuously or abruptly, an energy barrier is formed therebetween, and thus charges cannot be properly injected into the photosensitive layer. As a result, electrical properties of the photosensitive layer are easily degradable. To prevent this from occurring, it is preferable that at an interface region between the upper and lower photosensitive layer portions, compositions of the two layer portions are mixed with each other in such a manner that the concentration of the electron transporting material increases continuously towards the direction of the upper photosensitive layer portion. Such a configuration can be easily formed by forming a lower photosensitive layer portion on an electrically conductive layer in advance, and thereafter applying a composition for forming an upper photosensitive layer portion on the lower photosensitive layer portion to form an upper photosensitive layer portion, where the composition for forming the upper layer comprises an electron transporting material and a solvent in which the electron transporting material and the lower photosensitive layer portion can be dissolved. That is, a surface of the lower photosensitive layer portion is dissolved by applying the upper photosensitive layer portion so that the components of the lower photosensitive layer mix with the upper photosensitive layer portion. As a result, at an interface region between the upper and lower photosensitive layer portions, compositions of the two layer portions are mixed with each other in such a manner that the concentration of the electron transporting material increases continuously towards the direction of the upper photosensitive layer portion, and the upper photosensitive layer portion has a higher concentration of an electron transporting material than that of the lower photosensitive layer portion.

The solvent can vary according to the type of the binder resin used, and may be selected from optimum materials. Examples of such an organic solvent include alcohols such as methanol, ethanol, n-propanol or the like; ketones such as acetone, methyl ethyl ketone, cyclohexanone or the like; amides such as N,N-dimethylformamide, N,N-dimethylacetamide or the like; ethers such as tetrahydrofuran, dioxane, methylcellosolve or the like; esters such as methyl acetate, ethyl acetate or the like; sulfoxide such as dimethyl sulfoxide, sulfolane or the like and sulfones; halogenated aliphatic hydrocarbons such as methylene chloride, chloroform, carbon tetrachloride, trichloroethane or the like; and aromatic hydrocarbons such as benzene, toluene, xylene, monochlorobenzene, dichlorobenzene or the like. The solvent for the upper and lower photosensitive layers can be the same or different.

The upper and lower photosensitive layer portions can be formed using dip coating, ring coating, roller coating, spray coating or the like. However, when the dip coating is used, a difference in time at which the lower photosensitive layer portion contacts the composition for forming the upper photosensitive layer portion at an upper and lower parts of the electrophotographic photoreceptor occurs. Therefore, a mixing state at an interface region between the upper and the lower photosensitive layer portions is different at an upper and lower parts of the electrophotographic photoreceptor, which is not preferable. To avoid this state, ring coating, roller coating, spray coating or the like may be used.

In addition, the electrophotographic photoreceptor according to the present invention may further include a functional layer such as an undercoat layer formed between the electrically conductive substrate and the lower photosensitive layer portion, a surface protecting layer formed on the upper photosensitive layer portion or the like.

Hereinafter, an electrophotographic imaging apparatus according to the present invention will be described.

The electrophotographic imaging apparatus employs the electrophotographic photoreceptor according to the present invention.

FIG. 1 schematically illustrates an electrophotographic image forming apparatus according to an embodiment of the present invention. Referring to FIG. 1, reference numeral 1 refers to a semiconductor laser. Laser light that is signal-modulated by a control circuit 11 according to image information, after being radiated is collimated by an optical correction system 2 and performs scanning while being reflected by a polygonal rotatory mirror 3. The laser light is focused on a surface of an electrophotographic photoreceptor 5 by a scanning lens 4 and exposes the surface according to the image information. Since the electrophotographic photoreceptor is already charged by a charging apparatus 6, an electrostatic latent image is formed by the exposure, and then becomes visible by a developing apparatus 7. The visible image is transferred to an image receptor 12 such as paper by a transferring apparatus 8, and is fixed in a fixing apparatus 10 and provided as a print result. The electrophotographic photoreceptor can be used repeatedly by removing coloring agent that remains on the surface thereof by a cleaning apparatus 9. The electrophotographic photoreceptor here is shown in the form of a drum; however, as described above, it may also be in the form of a sheet or a belt.

Hereinafter, the present invention will be described in further detail with reference to the following examples. These examples are for illustrative purposes only and are not intended to limit the scope of the present invention. In addition, unless otherwise specified, the term “parts” refer to “parts by weight”.

### EXAMPLES

### Example 1

3 parts of X-type metal-free phthalocyanine was uniformly dispersed in a solution in which 60 parts by weight of a polycarbonate Z resin (Iupilon Z-200 manufactured by Mitsubishi gas chemical Co.) and 40 parts of a hole transporting material represented by Formula 1 below were dissolved in 300 parts of chloroform to prepare a dispersion for forming a lower photosensitive layer portion. Subsequently, the dispersion was coated on an aluminum drum having a diameter of 30 mm using a ring coating method, and then dried at 100° C. for one hour to form a lower photosensitive layer portion having a thickness of about 20 μm.

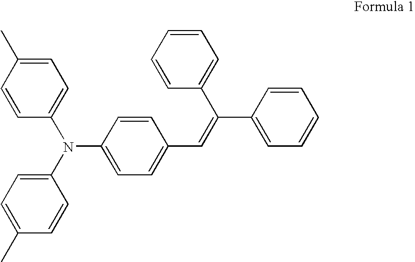

0.3 parts of X-type metal-free phthalocyanine was uniformly dispersed in a solution in which 6 parts of a polycarbonate Z resin (Iupilon Z-200) and 3 parts of an electron transporting material represented by Formula 2 below were dissolved in 190 parts of monochlorobenzene to prepare a dispersion for forming an upper photosensitive layer portion. Subsequently, the dispersion was coated on the lower photosensitive layer portion using a ring coating method, and then dried at 110° C. for 30 minutes to form an upper photosensitive layer portion. As a result, an electrophotographic photoreceptor was prepared. The total thickness (the sum of thicknesses of the upper and lower photosensitive layer portions) of the formed photosensitive layer was about 22 μm.

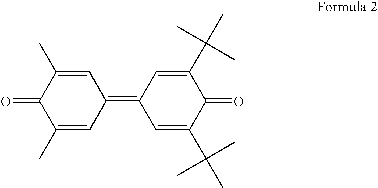

A part of the photosensitive layer was exfoliated to observe the cross section thereof using a microscope. As a result, coloration caused by the electron transporting material was observed within the range of about 5 μm from the outer surface side of the photosensitive layer. Therefore, it was confirmed that, at the upper photosensitive layer portions, the electron transporting material is present in a higher concentration.

### Example 2

An electrophotographic photoreceptor was prepared in the same manner as in Example 1, except that 30 parts of a hole transporting material represented by Formula 1 and 10 parts of an electron transporting material represented by Formula 2 were used instead of 40 parts of a hole transporting material represented by Formula 1 when preparing the dispersion for forming a lower photosensitive layer portion.

### Comparative Example 1

An electrophotographic photoreceptor was prepared in the same manner as in Example 1 by forming a photosensitive layer having a thickness of about 22 μm, except that only the dispersion for forming a lower photosensitive layer portion was used to form the photosensitive layer.

### Comparative Example 2

An electrophotographic photoreceptor was prepared in the same manner as in Example 2 by forming a photosensitive layer having a thickness of about 22 μm, except that only the dispersion for forming a lower photosensitive layer portion was used to form the photosensitive layer.

### Measurement of Electrical Properties

Electrical properties of each of the photosensitive layers of Examples 1 and 2, and Comparative Examples 1 and 2 were measured using a drum type photoreceptor evaluation apparatus (available from QEA INC., “PDT-2000”) under the condition of 23° C. and 50% relative humidity as follows.

Charging was performed at a corona voltage of 7 kV and at a relative speed of 100 mm/sec of the charging unit and the photoreceptor. Right after the charging process, monochromatic light having a wavelength of 780 nm was irradiated to the photosensitive layer at a light intensity of 10 mW/m2 for 5 seconds, and changes in the surface potential of the photosensitive layer was recorded. Herein, a surface electric potential before light irradiation was represented by V₀[V], and an electric potential 5 seconds after light irradiation was represented by Vᵢ[V]. In addition, irradiation energy was calculated from time consumed until V₀ was reduced to ½ and represented by E_{1/2}[mJ/m²]. That is, E_{1/2} (mJ/m2) denotes exposure energy that is required in order for the surface potential of the photoreceptor to become half of the initial potential (Vo) thereof. Next, repetition stability of electrical properties of the photosensitive layer was evaluated by measuring changes from the initial electrophotographic properties after repeating 100 cycles of charging the photosensitive layer and exposing them to light under the same conditions as described above, and then irradiating erasing light having a wavelength of 660 nm and a light exposure energy of 50 mJ/m².

The results are shown in Table 1 below.

TABLE 1

| Photoreceptor | State | V₀ [V] | Vᵢ [V] | E_{1/2} [mJ/m²] |
|---|---|---|---|---|
| Example 1 | Initial step | 710 | 44 | 4.27 |
| | Termination step | 694 | 52 | 4.35 |
| Comparative | Initial step | 712 | 53 | 5.14 |
| Example 1 | Termination step | 636 | 131 | 6.15 |
| Example 2 | Initial step | 706 | 28 | 3.98 |
| | Termination step | 704 | 35 | 4.05 |
| Comparative | Initial step | 709 | 31 | 4.42 |
| Example 2 | Termination step | 702 | 43 | 4.49 |

Referring to Table 1, it can be seen that the photoreceptor of Comparative Example 1 does not contain an electron transporting material on a surface of a photosensitive layer on which charges are mostly generated and thus generated electrons do not migrate, resulting in high residual potential, while the photoreceptor of Example 1 has much higher sensitivity than that of the photoreceptor of Comparative Example 1. Also, the photoreceptor of Example 2 has excellent repetition stability of electrical properties.

In addition, comparing the photoreceptor of Example 2 with the photoreceptor of Comparative Example 2, both of which contain an electron transporting material even in the lower photosensitive layer portion or in the lower portion of the photosensitive layer adjoining the electrically conductive substrate, it can be seen that the photoreceptor of Example 2 has higher sensitivity and also excellent repetition stability of electrical properties.

As described above, the single-layered type electrophotographic photoreceptor according to the present invention, having the structural features as described above, shows high sensitivity and excellent repetition stability of electrical properties, while still having advantages of a conventional single-layered photoreceptor, thereby being able to have highly practical applications.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electrophotographic photoreceptor comprising a photosensitive layer formed on an electrically conductive substrate, the photosensitive layer comprising a charge generating material, a charge transporting material and a binder resin in a single layer, wherein the single photosensitive layer comprises an upper photosensitive layer portion and a lower photosensitive layer portion, and the electron transporting material of the upper photosensitive layer portion is present in a higher concentration than that of the lower photosensitive layer portion.

2. The electrophotographic photoreceptor of claim 1, wherein an interface region between the upper and lower photosensitive layer portions comprises a mixture of the two layer portions such that the concentration of the electron transporting material increases continuously towards the direction of the upper photosensitive layer portion.

3. The electrophotographic photoreceptor of claim 1, wherein the photosensitive layer further comprises a hole transporting material, and wherein a hole transporting material of the lower photosensitive layer portion has a higher concentration than a concentration of a hole transporting material of the upper photosensitive layer portion.

4. The electrophotographic photoreceptor of claim 1, wherein the upper photosensitive layer portion comprises a binder resin, and a charge generating material, an electron transporting material and a hole transporting material that are dispersed or dissolved in the binder resin, the lower photosensitive layer portion comprises a binder resin, and a charge generating material and a hole transporting material that are dispersed or dissolved in the binder resin,
in the upper photosensitive layer portion, the amounts of the charge generating material, the electron transporting material and the hole transporting material, are about 0.1-200 parts by weight, about 15-300 parts by weight and about 5-100 parts by weight, respectively, based on 100 parts by weight of the binder resin, and
in the lower photosensitive layer portion, the amounts of the charge generating material and the hole transporting material, are about 0.1-200 parts by weight and about 20-400 parts by weight, respectively, based on 100 parts by weight of the binder resin.

5. The electrophotographic photoreceptor of claim 4, wherein the lower photosensitive layer portion further comprises about 5-100 parts by weight of the electron transporting material based on 100 parts by weight of the binder resin.

6. The electrophotographic photoreceptor of claim 1, wherein the electrophotographic photoreceptor is a positive charge-type electrophotographic photoreceptor.

7. A method of preparing an electrophotographic photoreceptor, comprising:
forming a lower photosensitive layer portion on an electrically conductive substrate; and
applying a composition for forming an upper photosensitive layer portion onto the lower photosensitive layer portion to form an upper photosensitive layer portion, wherein the composition comprises an electron transporting material and a solvent in which the electron transporting material and the lower photosensitive layer portion can be dissolved, whereby an interface region is formed between the upper and lower photosensitive layer portions, comprising a mixture of the two layer portions such that the concentration of the electron transporting material increases continuously towards the direction of the upper photosensitive layer portion, and the upper photosensitive layer portion has a higher concentration of an electron transporting material than that of the lower photosensitive layer portion.

8. The method of claim 7, wherein the forming of the lower photosensitive layer portion comprises applying and drying a composition for forming the lower photosensitive layer portion on the electrically conductive substrate, where the composition comprises a binder resin, a charge generating material, a hole transporting material and a solvent,
the forming of an upper photosensitive layer portion comprises applying and drying a composition for forming an upper photosensitive layer portion on the lower photosensitive layer portion where the composition comprises a binder resin, a charge generating material, an electron transporting material and a solvent, the solvent being able to dissolve at least the electron transporting material and the lower photosensitive layer portion, on the lower photosensitive layer portion,
in the composition for forming a lower photosensitive layer portion, the amounts of the charge generating material, the hole transporting material and the solvent, are about 0.1-200 parts by weight, about 20-400 parts by weight and about 50-1000 parts by weight, respectively, based on 100 parts by weight of the binder resin, and
in the composition for forming an upper photosensitive layer portion, the amounts of the charge generating material, the electron transporting material, a hole transporting material and the solvent are about 0.1-200 parts by weight, about 15-300 parts by weight, about 5-100 parts by weight and about 50-1000 parts by weight, respectively, based on 100 parts by weight of the binder resin.

9. The method of claim 7, wherein the composition for forming a lower photosensitive layer portion further comprises about 5-100 parts by weight of the electron transporting material based 100 parts by weight of the binder resin.

10. An electrophotographic imaging apparatus comprising:
an electrophotographic photoreceptor; a charging unit that charges a photosensitive layer of the electrophotographic photoreceptor; a light exposure unit that forms a latent image on a surface(of the photosensitive layer of the electrophotographic photoreceptor by light exposure using laser light; and a developer that develops the latent image,
wherein the electrophotographic photoreceptor comprises a photosensitive layer comprising a charge generating material, a charge transporting material and a binder resin in a single layer formed on an electrically conductive substrate, and wherein the single photosensitive layer comprises an upper photosensitive layer portion and a lower photosensitive layer portion, and where the electron transporting material of the upper photosensitive layer portion has a higher concentration than that of the lower photosensitive layer portion.

11. The apparatus of claim 10, wherein an interface region between the upper and lower photosensitive layer portions comprises a mixture of the two layer portions such that the concentration of the electron transporting material increases continuously towards the direction of the upper photosensitive layer portion.

12. The apparatus of claim 10, wherein the hole transporting material of the lower photosensitive layer portion has a higher concentration than the hole transporting material of the upper photosensitive layer portion.

13. The apparatus of claim 10, wherein the upper photosensitive layer portion comprises a binder resin, and a charge generating material, an electron transporting material and a hole transporting material that are dispersed or dissolved in the binder resin,
the lower photosensitive layer portion comprises a binder resin, and a charge generating material and a hole transporting material that are dispersed or dissolved in the binder resin,
in the upper photosensitive layer portion, the amounts of a charge generating material, an electron transporting material and a hole transporting material, are about 0.1-200 parts by weight, about 15-300 parts by weight and about 5-100 parts by weight, respectively, based on 100 parts by weight of the binder resin, and
in the lower photosensitive layer portion, the amounts of a charge generating material and a hole transporting material, are about 0.1-200 parts by weight and about 20-400 parts by weight, respectively, based on 100 parts by weight of the binder resin.

14. The apparatus of claim 13, wherein the lower photosensitive layer portion further comprises about 5-100 parts by weight of the electron transporting material based on 100 parts by weight of the binder resin.

15. An electrophotographic photoreceptor comprising:
an electrically conductive substrate; and
a photosensitive layer formed on the electrically conductive substrate, the photosensitive layer including a charge generating material, a charge transporting material dispersed in a binder resin and formed as a single layer, with an upper surface and a lower surface on the substrate, wherein the concentration of the electron transporting material in the photosensitive layer increases from the lower surface toward the upper surface.

16. The electrophotographic photoreceptor of claim 15, wherein the photosensitive layer includes an interface region position between the upper and lower surfaces and wherein the concentration of the electron transporting material continuously increases from the lower surface to the upper surface.

17. The electrophotographic photoreceptor of claim 16, wherein the photosensitive layer has an upper layer portion and a lower layer portion with the interface region formed between the upper layer portion and lower layer portion, and where the concentration of the electron transporting material is higher in the upper layer portion than the lower layer portion.

18. The electrophotographic photoreceptor of claim 17, where the concentration of the hole transporting material is lower in the upper layer portion than in the lower layer portion.
